(19) United States
(12) Patent Application Publication
(10) Pub. No.: US 2012/0050640 A1
(43) Pub. Date: Mar. 1, 2012

(54) LIQUID CRYSTAL DISPLAY DEVICE

(75) Inventors: Yoichi YASUI, Chiba (JP); Takenori YAGUCHI, Chiba (JP); Masato YANAI, Chiba (JP)

(73) Assignee: Panasonic Liquid Crystal Display Co., Ltd., Himeji-shi (JP)

(21) Appl. No.: 13/214,821

(22) Filed: Aug. 22, 2011

(30) Foreign Application Priority Data
Aug. 25, 2010 (JP) 2010-188832

(51) Int. Cl. G02F 1/1333

(52) U.S. Cl. 349/60; 349/58

(57) ABSTRACT

A liquid crystal display device (1) comprises a liquid crystal panel (2) and a support frame (4) encompassing the edge of the liquid crystal panel (2). The lower side portion (41) of the support frame (4) includes a support portion (41b) on which the lower edge (2a) of the liquid crystal panel (2) is placed. The lower edge (2a) of the liquid crystal panel (2) is adhered on the upper surface of the support portion (41b). With the above, occurrence of irregular color due to distortion of the liquid crystal panel is able to be reduced.

### CROSS-REFERENCE TO RELATED APPLICATION

The present application claims priority from Japanese application JP2010-188832 filed on Aug. 25, 2010, the content of which is hereby incorporated by reference into this application.

### BACKGROUND OF THE INVENTION

1. Field of the Invention

The present invention relates to a structure of a liquid crystal display device where a liquid crystal panel is supported by a frame.

2. Description of the Related Art

A liquid crystal display device has a liquid crystal panel and a frame that encompasses the peripheral edge of the liquid crystal panel (e.g., Japanese Patent Laid-open Publication No. 2005-275103). In a liquid crystal display device used in a television set (TV) or the like, the liquid crystal panel is held standing with its display screen directed forward and its lower edge mounted on a support portion formed on the lower side portion of the frame.

### SUMMARY OF THE INVENTION

A liquid crystal panel used in a TV set or the like is assembled with a frame to thereby constitute a display module. A liquid crystal panel that employs IPS (In-Plane-Switching) mode cannot be closely adhered on the frame due to a characteristic thereof that a localized stress to the liquid crystal panel from the frame will cause irregular color on the display. In addition, it is often a case that a liquid crystal panel is slightly curved. Therefore, the width of the support portion of the frame needs to be slightly larger than the thickness of the liquid crystal panel so that such a curved liquid crystal panel can be mounted on the support portion of the frame without causing a stress described above.

In such a structure where the width of the support portion is slightly larger than the thickness of the liquid crystal panel, when a lowermost part (in particular, left and right ends of the lowermost part) of the front surface of the panel is pressed, the liquid crystal panel is distorted, and the lower edge of the liquid crystal panel resultantly moves relative to the support portion. In the above, a stress is applied to the liquid crystal panel, causing irregular color on the display screen. In this case, if the lower edge of the liquid crystal panel can move back to its original position when the pressing force is released, the irregular color will no longer remain.

However, the recent trend toward larger in size of liquid crystal panels for TV sets and thus heavier in weight of large-scaled liquid crystal panels leads to increase of friction between the support portion of the frame and the lower edge of a liquid crystal panel due to the weight of the liquid crystal panel itself. This may lead to a case in which the lower edge of a liquid crystal panel, which has moved when a lowermost part of the panel surface has been pressed, does not return to its original position as being stopped by the support portion of the frame. In this case, irregular color remains.

The present invention has been conceived in view of the above, and an object thereof is to provide a liquid crystal display device capable of reducing occurrence of irregular color due to distortion of a liquid crystal panel.

In order to achieve the above described object, according to one aspect of the present invention, there is provided a liquid crystal display device, comprising a liquid crystal panel; and a frame encompassing an edge of the liquid crystal panel. A lower side portion of the frame includes a support portion on which a lower edge of the liquid crystal panel is placed, the support portion has a width that is larger than a thickness of the liquid crystal panel. The lower edge of the liquid crystal panel is adhered on the upper surface of the support portion.

According to the present invention, it is possible to prevent the lower edge of a liquid crystal panel from moving relative to the upper surface of the support portion when the lowermost part of the front surface of the liquid crystal panel is pressed. As a result, it is possible to prevent the lower edge from being stopped by the support portion due to a friction force and then not returning to its original position. Accordingly, it is possible to prevent occurrence of irregular color due to distortion of the liquid crystal panel.

In an embodiment of the present invention, an adhesive surface may be provided on the upper surface of the support portion, and the lower edge of the liquid crystal panel may be placed on the adhesive surface. In this embodiment, a liquid crystal panel can be readily adhered onto the support portion.

In this embodiment, the frame may have a plurality of support portions, each serving as the support portion, that are positioned apart from each other in a direction along the lower edge of the liquid crystal panel, and the adhesive surface may be provided to each of the plurality of support portions. With the above, movement of the lower edge of the liquid crystal panel can be more strictly regulated.

In an embodiment of the present invention, the lower edge of the liquid crystal panel may be adhered on the upper surface of the support portion through an attaching member placed on the support portion. The attaching member may include a first surface adhered on the liquid crystal panel and a second surface adhered on the support portion, and further include, between the first surface and the second surface, a flexible material for allowing displacement between the first surface and the second surface. With the above, when a liquid crystal panel is deformed due to heat that is generated while a liquid crystal display device is used, the deformation can be more readily allowed, and generation of stress on a liquid crystal panel can thus be reduced. As a result, even when a liquid crystal panel is slightly deformed due to heat, occurrence of irregular color can be prevented.

According to another aspect of the present invention, there is provided a liquid crystal display device comprising a liquid crystal panel; and a frame encompassing an edge of the liquid crystal panel. A lower side portion of the frame includes a support portion for supporting a lower edge of the liquid crystal panel. The support portion has a width larger than a thickness of the liquid crystal panel. The lower edge of the liquid crystal panel is placed on the upper surface of the support portion through an attaching member placed on the support portion. The attaching member has an elastic member having flexibility and an adhesive surface adhered on the support portion. According to this aspect, as the lower edge of the liquid crystal panel can be mounted on the attaching member so as to sink into the attaching member, it is possible to regulate movement of the lower edge of the liquid crystal panel relative to the upper surface of the support portion when the lowermost part of the front surface of the liquid crystal panel is pressed. Further, even when the lower edge of the liquid crystal panel is displaced in its position, the lower edge of the liquid crystal panel can be returned to its original position due to the elastic force of the elastic member.

### BRIEF DESCRIPTION OF THE DRAWINGS

FIG. 1 is a perspective cross sectional view of a lowermost part of a liquid crystal device according to an embodiment of the present invention;

FIG. 2 is an exploded perspective view showing a liquid crystal panel, a support frame, and a front frame of the above described liquid crystal display device;

FIG. 3 is a front view showing a part of the above described support frame and liquid crystal panel, particularly showing enlarged a lower right part of the support frame and liquid crystal panel; and

FIG. 4 is a cross sectional view showing a lowermost part of a liquid crystal display device according to another embodiment of the present invention.

### DETAILED DESCRIPTION OF THE INVENTION

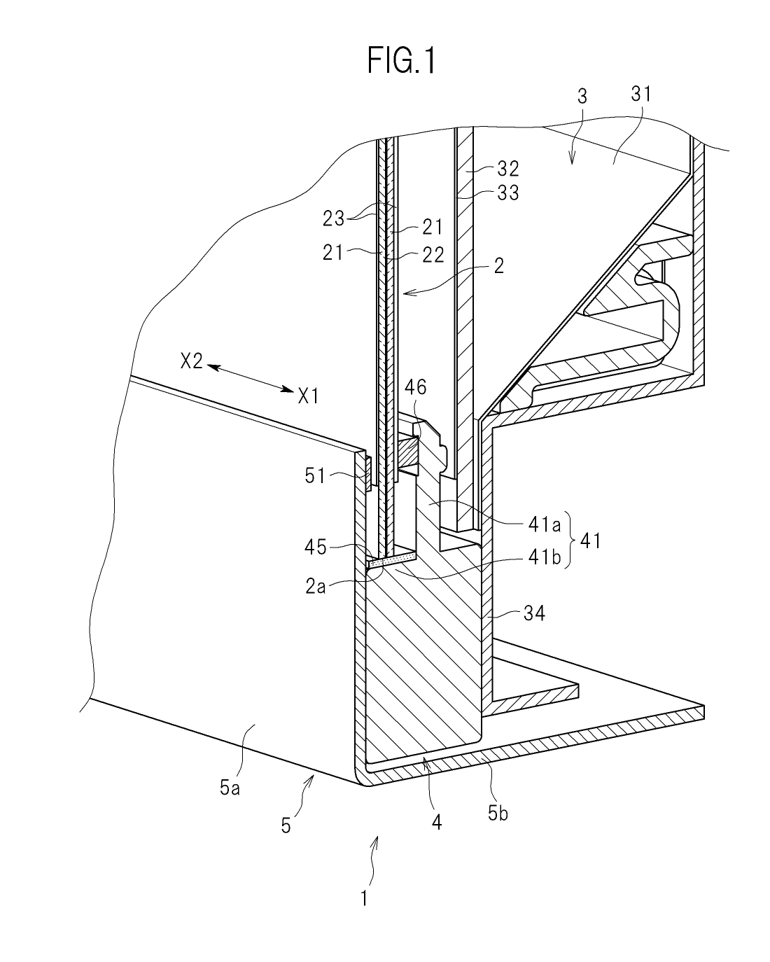

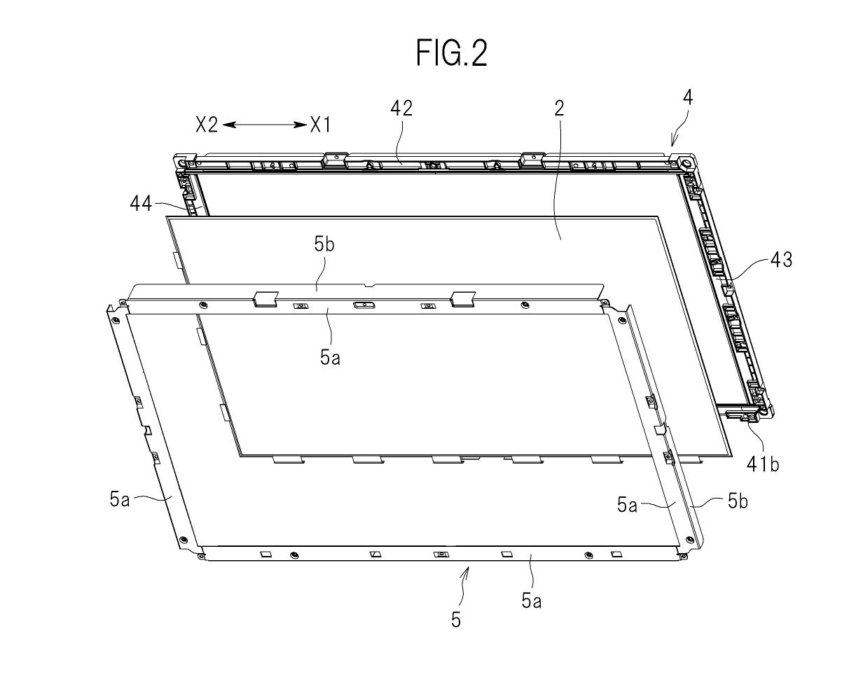

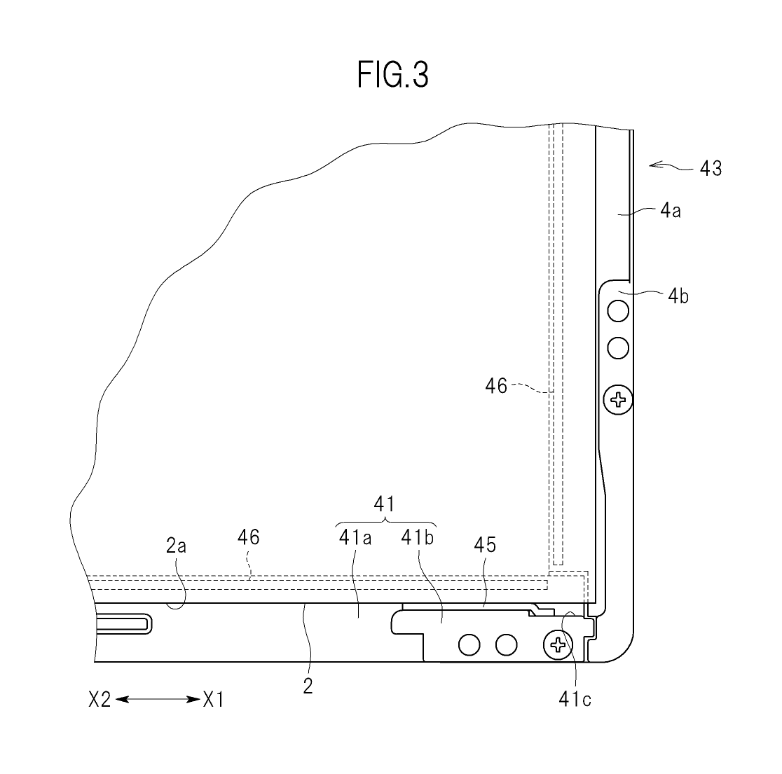

In the following, an embodiment of the present invention will be described with reference to the accompanying drawings. FIG. 1 is a perspective cross sectional view of a lowermost part of a liquid crystal display device 1, which is an example of an embodiment of the present invention. FIG. 2 is an exploded perspective view showing a liquid crystal panel 2, a support frame 4, and a front frame 5 of the liquid crystal display device 1. FIG. 3 is a front view showing a part of the support frame 4 and liquid crystal panel 2, specifically, showing enlarged aright lower part of the support frame 4 and liquid crystal panel 2.

As shown in FIG. 1, the liquid crystal display device 1 includes a liquid crystal panel 2, which is rectangular, as shown in FIG. 2. The liquid crystal display device 1 holds the liquid crystal panel 2 standing upright with its display screen (front surface) facing forward. The liquid crystal display device 1 may be, e.g., a display device of a TV set.

The liquid crystal panel 2 includes a pair of light transmissive substrates 21 (specifically, a glass substrate) 21, including one being a TFT substrate having a TFT (Thin Film Transistor) formed thereon and the other having a color filter formed thereon. The two substrates 21 are arranged to face to each other with a slight space in-between, and a liquid crystal 22 is sealed between the two substrates 21. The liquid crystal 22 in this example is driven in IPS (In-Plane-Switching) mode. The liquid crystal panel 2 further includes two polarizing filters 23 arranged with a space in-between. The pair of substrates 21 are placed between the two polarizing filters 23, which are adhered on the respective surfaces of the substrates 21. The polarizing filer 23 is shorter in vertical and horizontal size than the substrate 21, so that a lowermost part of the substrate 21 is located beyond downward the lower edge of the polarizing filter 23. As shown in FIG. 1, the liquid crystal display device 1 has a backlight unit 3 provided behind the liquid crystal panel 2 for irradiating light toward the liquid crystal panel 2. The backlight unit 3 comprises a reflection sheet 31 for reflecting light from a light source (not shown) toward the liquid crystal panel 2, a diffusing panel 32 for diffusing a light from the light source and a light that reflected on the reflection sheet 31, an optical sheet 33, and a lower frame 34 for holding the light source and the reflection sheet 31.

In addition, as shown in FIG. 1 or FIG. 2, the liquid crystal display device 1 further includes a rectangular support frame 4 and a rectangular front frame 5 both in size corresponding to the outer circumference of the liquid crystal panel 2. The support frame 4 and the front frame 5 are assembled to each other in the thickness direction of the liquid crystal panel 2 so as to together encompass the outer circumferential edge of the liquid crystal panel 2. The support frame 4 is formed by molding, e.g., resin.

As shown in FIG. 1 or FIG. 3, the support frame 4 includes a lower side portion 41. The lower side portion 41 is positioned along the lower edge 2a (lower edges of the pair of substrates 21) of the liquid crystal panel 2 and extends from one end to the other end of the lower edge 2a. The lower side portion 41 includes a rear wall 41a and a support portion 41b. The rear wall 41a is formed along the rear surface of the liquid crystal panel 2. That is, one surface of the rear wall 41a faces to the rear surface of the liquid crystal panel 2 in the thickness direction of the liquid crystal panel 2. Meanwhile, the support portion 41b extends forward from the rear wall 41a (see FIG. 2) such that the upper surface thereof faces to the lower edge (lower end surface) 2a of the liquid crystal panel 2 in the up-down direction.

As shown in FIG. 1 or FIG. 3, the lower edge 2a of the liquid crystal panel 2 is mounted on and thereby supported by the support portion 41b. The upper surface of the support portion 41b is elongate in the direction (the left-right direction (the X1-X2 direction)) along the lower edge 2a of the liquid crystal panel 2 and remains horizontal. The support portion 41b is provided only near the respective ends of the lower edge 2a of the liquid crystal panel 2. That is, a support portion 41b is formed also on the other end of the lower edge 2a of the liquid crystal panel 2 that is not shown in FIG. 3. Alternatively, the upper surface of the support portion 41b may not be horizontal, and may be curved so as to swell upward. Such a form of the upper surface of the support portion 41b can reduce an area where the support portion 41b contacts the lower edge 2a of the liquid crystal panel 2.

As the plurality of (two here) support portions 41b provided on the lower side portion 41 are located apart from each other in the left-right direction, the lower edge 2a of the liquid crystal panel 2 is partially supported by those support portions 41b. In this example, two support portions 41b are provided on the respective both ends of the lower side portion 41 and support the right and left respective ends of the lower edge 2a of the liquid crystal panel 2. In other words, the lower edge 2a of the liquid crystal panel 2 is supported only by these two support portions 41b, and the portion between the two support portions 41b is not in contact with the lower edge 2a of the liquid crystal panel 2.

As shown in FIG. 2 or FIG. 3, the support frame 4 additionally includes an upper side portion 42, a right side portion 43, and a left side portion 44 positioned along the upper, right, and left respective edges of the liquid crystal panel 2, and these portions 42, 43, 44 include respective rear walls 4a. Similar to the rear wall 41a of the lower side portion 41, the rear wall 4a is formed along the rear surface of the liquid crystal panel 2. The respective portions 42, 43, 44 have outer walls 4b so that the outer walls 4b together encompass the outer circumferential edge (that is, the end surface (a surface defining the thickness of the liquid crystal panel 2)) while facing to the outer circumferential edge in the in-plane direction (in an up-down or left-right direction) of the liquid crystal panel 2.

As shown in FIG. 1 or FIG. 3, an elongate elastic cushion 46 is provided on the rear wall 41a and all of the rear walls 4a. Specifically, the cushion 46 is adhered on the surface of the rear wall 41a, 4a toward the liquid crystal panel 2. That is, the cushion 46 is positioned between the rear surface of the liquid crystal panel 2 and the rear wall 4a, 41a, and thereby prevents the liquid crystal panel 2 from directly hitting on the rear wall 4a, 41a. Moreover, when the outer circumferential portion of the front surface of the liquid crystal panel 2 is pressed, the cushion 46 exerts a force to return the output circumferential portion of the liquid crystal panel 2 to its original position.

As shown in FIGS. 1 and 2, the front frame 5 and the support frame 4 are assembled to each other so as to together sandwich the output circumferential portion of the liquid crystal panel 2. A respective side portion of the front frame 5 is formed having a substantially L-shaped cross section constituted of a front wall 5a and an outer wall 5b formed as being bent at the edge of the front wall 5a. The front wall 5a is arranged to face to the front surface (a display screen) of the liquid crystal panel 2 in the thickness direction of the liquid crystal panel 2. The outer wall 5b is positioned outside the outer wall 4b of the support frame 4, encompassing the outer circumferential surface of the support frame 4.

As shown in FIG. 1, an elastic elongate cushion 51 is provided on the front wall 5a of a respective side portion of the front frame 5. Specifically, the cushion 51 is adhered on the surface of the front wall 5a toward the liquid crystal panel 2. Being positioned between the front surface of the liquid crystal panel 2 and the front wall 5a, the cushion 51 prevents the liquid crystal panel 2 from directly abutting on the front wall 5a.

As shown in FIG. 1, a space is ensured between the front wall 5a of the front frame 5 and the rear wall 4a, 41a of the support frame 4, and the output circumferential portion of the liquid crystal panel 2 is arranged between the front wall 5a and the rear wall 4a, 41a. The interval between the front wall 5a and the rear wall 4a, 41a is larger than the thickness of the liquid crystal panel 2. Specifically, when the front frame 5 is assembled with the support frame 4, the front wall 5a abuts on the support portion 41b and the outer wall 4b. And thus, the interval between the front wall 5a and the rear wall 4a, 41a is defined by the width (the width in the thickness direction of the liquid crystal panel 2) of the support portion 41b and that (similarly, the width in the thickness direction) of the outer wall 4b. The width of the support portion 41b and that of the outer wall 4b are larger than the thickness of the liquid crystal panel 2. Therefore, the interval between the front wall 5a and the rear wall 41a, 4a is larger than the thickness of the liquid crystal panel 2. This makes it possible to assemble the front frame 5 to the support frame 4 without causing a stress on the liquid crystal panel 2 even when the liquid crystal panel 2 is slightly curved. Moreover, because a large-scaled liquid crystal panel 2 is slightly curved in many cases, the output circumferential portion of such a liquid crystal panel 2 abuts partially on the front wall 5a and the rear wall 4a, 41a. This resultantly can prevent the liquid crystal panel 2 from being shaky in the support frame 4 and the front frame 5.

As described above, the lower edge 2a of the liquid crystal panel 2 is supported by the support portion 41b. The lower edge 2a of the liquid crystal panel 2 is mounted on the upper surface of the support portion 41b without causing a stress in the thickness direction to the liquid crystal panel 2. In this embodiment, the lower edge 2a of the liquid crystal panel 2 is adhered on the upper surface of the support portion 41b. That is, the surface (the lower edge 2a) of the liquid crystal panel 2 that faces downward is attached on the upper surface of the support portion 41b in the vertical direction.

In this example, an adhesive surface having a width (i.e., a width in the thickness direction) larger than the thickness of the liquid crystal panel 2 is provided on the upper surface of the support portion 41b. The lower edge 2a of the liquid crystal panel 2 is placed on the adhesive surface. In detail, a thin attaching member having adhesive surfaces on the respective both surfaces thereof (i.e., on the top and bottom surfaces thereof) is provided on the support portion 41b.

Specifically, an adhesive tape 45 is provided on the support portion 41b. The respective both surfaces of the adhesive tapes 45, where adhesive agent is applied, function as adhesive surfaces. The adhesive tape 45 is adhered on the upper surface of the support portion 41b. The lower edge 2a of the liquid crystal panel 2 is placed on the adhesive tape 45 and adhered through the adhesive tape 45 on the upper surface of the support portion 41b.

The adhesive tape 45 has a width corresponding to that of the support portion 41b. In detail, one edge of the adhesive tape 45 along the length direction is in contact with the rear wall 41a, while the other edge is positioned slightly more inside than the edge of the upper surface of the support portion 41b.

As shown in FIG. 3, the upper surface of the support portion 41b forms an elongate horizontal surface extending along the lower edge 2a of the liquid crystal panel 2. Accordingly, there can be ensured a wide adhering area between the lower edge 2a of the liquid crystal panel 2 and the upper surface of the support portion 41b.

The adhesive tape 45 is an elongate band extending along the lower edge 2a of the liquid crystal panel 2.

The adhesive tape 45 in this embodiment is longer than the length of the upper surface of the support portion 41b. Therefore, one end of the adhesive tape 45 is located beyond, and thus outside, the support portion 41b in the left-right direction (in the right direction in FIG. 3). Accordingly, the end of the adhesive tape 45 is adhered on the upper surface 41c, which is lower in height than the upper surface of the support portion 41b. This makes the adhesive tape 45 less likely to be peeled off.

The adhesive tape 45 is made of flexible material, and allows, by the flexibility thereof, a displacement (a change of position) of the upper surface thereof (a surface on which the lower edge 2a of the liquid crystal panel 2 is adhered) relative to the lower surface thereof (a surface adhered on the support portion 41b). That is, the position of the upper surface of the adhesive tape 45 can move slightly in the horizontal direction (specifically, in the front-back or left-right direction) relative to the lower surface. The adhesive tape 45 is made of a thin foam, such as, e.g., a urethane foam, a polyethylene foam, a vinyl foam, a styrene foam, and so forth, and thus has both of flexibility and elasticity. Adhesive agent is applied on the respective both surfaces of the foam.

Therefore, when the liquid crystal panel 2 should be slightly deformed due to heat caused when the liquid crystal display device 1 is used, change in position of the lower edge 2a can be allowed. As a result, a stress on the liquid crystal panel 2 can be reduced and consequently irregular color can also be prevented, even when the liquid crystal panel 2 is slightly deformed due to heat.

Because the adhesive tape 45 has also elasticity, even when the liquid crystal panel 2 is pressed from outside, the adhesive tape 45 exerts a force to return the lower edge 2a of the liquid crystal panel 2 to its original position.

Note that a method for adhering the lower edge 2a of the liquid crystal panel 2 on the upper surface of the support portion 41b is not limited to that described above. Alternatively, for example, the lower edge 2a of the liquid crystal panel 2 may be directly adhered on the upper surface of the support portion 41b, using adhesive agent. Further, adhesive agent may be applied on, or an adhesive tape may be adhered on, the lower edge 2a of the liquid crystal panel 2. Still further, the lower edge 2a of the liquid crystal panel 2 may be adhered on the upper surface of the support portion 41b, using an adhesive agent or paste of thermosetting resin that are supplied onto the upper surface of the support portion 41b after the lower edge 2a is placed on the upper surface of the support portion 41b.

As described above, according to the liquid crystal display device 1, the lower edge 2a of the liquid crystal panel 2 is adhered on the upper surface of the support portion 41b.

Therefore, even when the right or left end of the lowermost part of the front surface of the liquid crystal panel 2 is pressed, the lower edge 2a of the liquid crystal panel 2 is hardly changed in its position relative to the upper surface of the support portion 41b. As a result, the lower edge 2a of the liquid crystal panel 2, having been moved relative to the upper surface of the support portion 41b, can be prevented from being stopped by friction force from the upper surface of the support portion 41b. This can prevent occurrence of irregular color on the display screen.

Further, even when the liquid crystal display device 1 shakes in transportation or the like, the position of the liquid crystal panel 2 relative to the support frame 4 and the front frame 5 remains unchanged. This can reduce an impact applied to the liquid crystal panel 2, and resultantly improve durability of the liquid crystal display device 1.

Further, when the liquid crystal panel 2 is curved, the position of the lower edge 2a on the upper surface of the support portion 41b may differ depending on the extent of curvature. In the above described embodiment, however, because the lower edge 2a is adhered on the upper surface of the support portion 41b, the lower edge 2a can be fixedly mounted in a position according to the extent of curvature of the liquid crystal panel 2.

Note that the present invention is not limited to the above described liquid crystal display device 1, and is adapted to various modifications.

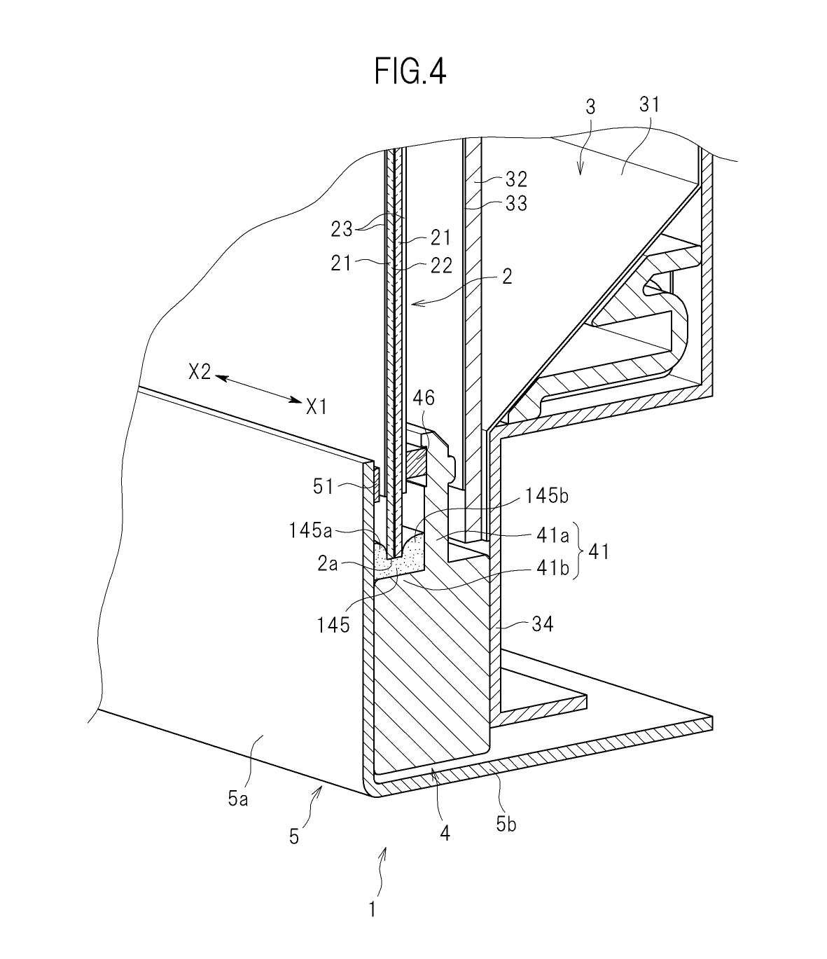

For example, the lower edge 2a of the liquid crystal panel 2 may not be adhered directly on the support portion 41b and may rather be placed on an attaching member comprising a flexible elastic member and having an adhesive surface to be adhered on the upper surface of the support portion 41b. FIG. 4 is a cross sectional view of a liquid crystal display device according to this embodiment. In FIG. 4, a portion identical to a portion having been described above is given an identical reference numeral.

In FIG. 4, the lower edge 2a of the liquid crystal panel 2 is placed on an attaching member 145 comprising a foam (an elastic member), such as a low backlash urethane foam, that is thicker than the foam of the adhesive tape 45. The attaching member 145 has a shape equivalent, in a plan view, to that of the above described adhesive tape 45, but is thicker than the adhesive tape 45. An adhesive agent is applied only on one surface (a lower surface (an adhesive surface)) of the attaching member 145, and that surface is adhered on the support portion 41b. Because the foam of the attaching member 145 has flexibility and elasticity in the thickness direction thereof, the lower edge 2a of the liquid crystal panel 2 sinks into the attaching member 145 due to its own weight. As a result, the lower edge 2a of the liquid crystal panel 2 is sandwiched between the foam 145a, which is arranged into between the liquid crystal panel 2 and the front wall 5a, and the foam 145b which is arranged into between the liquid crystal panel 2 and the rear wall 41a. With the above, movement of the liquid crystal panel 2 is regulated, and the liquid crystal panel 2 can return to its original position due to a restoring force of the foam even when an external pressure is applied to the liquid crystal panel 2. In the above described liquid crystal display device 1, the adhesive tape 45 is made of a flexible and elastic foam. Alternatively, the adhesive tape 45 may be made of a relatively rigid material such as polyethylene terephthalate.

In the above description, the support portion 41b of the support frame 4 is provided on the respective both ends of the lower side portion 41. Alternatively, the position of the support portion 41b is not limited to the position described above, and for example, the support portion 41b may be positioned closer to the middle of the lower side portion 41, rather than the ends. While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device, comprising:
a liquid crystal panel; and
a frame encompassing an edge of the liquid crystal panel,
wherein
a lower side portion of the frame includes a support portion on which a lower edge of the liquid crystal panel is placed,
the support portion has a width that is larger than a thickness of the liquid crystal panel, and
the lower edge of the liquid crystal panel is adhered on an upper surface of the support portion.

2. The liquid crystal display device according to claim 1, wherein
an adhesive surface is provided on the upper surface of the support portion, and
the lower edge of the liquid crystal panel is placed on the adhesive surface.

3. The liquid crystal display device according to claim 2, wherein
the frame has a plurality of support portions each serving as the support portion, that are positioned apart from each other in a direction along the lower edge of the liquid crystal panel, and
the adhesive surface is provided to each of the plurality of support portions.

4. The liquid crystal display device according to claim 1, wherein
the lower edge of the liquid crystal panel is adhered on the upper surface of the support portion through a attaching member placed on the support portion, and
the attaching member includes a first surface adhered on the liquid crystal panel and a second surface adhered on the support portion, and further includes, between the first surface and the second surface, a flexible material for allowing displacement between the first surface and the second surface.

5. A liquid crystal display device, comprising:
a liquid crystal panel; and
a frame encompassing an edge of the liquid crystal panel,
wherein
a lower side portion of the frame has a support portion for supporting a lower edge of the liquid crystal panel,
the support portion has a width larger than a thickness of the liquid crystal panel,
the lower edge of the liquid crystal panel is placed on an upper surface of the support portion through an attaching member placed on the support portion, and
the attaching member has an elastic member having flexibility and an adhesive surface adhered on the support portion.
